(19) United States
(12) Patent Application Publication
(10) Pub. No.: US 2012/0237827 A1
(43) Pub. Date: Sep. 20, 2012

(54) POROUS METAL BODY, METHOD FOR PRODUCING THE SAME, AND MOLTEN-SALT BATTERY

(75) Inventors: Atsushi FUKUNAGA, Osaka-shi (JP); Shinji Inazawa, Osaka-shi (JP); Masatoshi Majima, Osaka-shi (JP); Atsushi Yamaguchi, Osaka-shi (JP); Koji Nitta, Osaka-shi (JP); Shoichiro Sakai, Osaka-shi (JP)

(73) Assignee: SUMITOMO ELECTRIC INDUSTRIES, LTD., Osaka-shi (JP)

(21) Appl. No.: 13/368,643

(22) Filed: Feb. 8, 2012

Related U.S. Application Data
(63) Continuation of application No. PCT/JP2011/072721, filed on Oct. 3, 2011.

(30) Foreign Application Priority Data
Oct. 13, 2010 (JP) 2010-230656

(51) Int. Cl. H01M 4/38; B32B 15/01; B32B 5/18

(52) U.S. Cl. 429/218.1; 428/613; 427/123

(57) ABSTRACT

A porous metal body includes a porous skeleton that forms a three-dimensional network structure and includes an aluminum layer having a thickness of 1 to 100 μm, and tin layers disposed on an internal surface and an external surface of the aluminum layer. Such a porous metal body can be produced by an internal-tin-layer formation step of forming a tin layer on a surface of a resin molded body having a three-dimensional network structure; an aluminum-skeleton formation step of forming an aluminum layer serving as an aluminum skeleton on a surface of the internal tin layer; an external-tin-layer formation step of forming a tin layer on a surface of the aluminum skeleton; and a resin removal step of removing the resin molded body, the resin removal step being performed after the aluminum-skeleton formation step or after the external-tin-layer formation step.

### CROSS REFERENCES TO RELATED APPLICATIONS

This is a continuation application of International Application No. PCT/JP2011/072721 filed on Oct. 3, 2011, claiming the benefit of priority from Japanese Patent Application No. 2010-230656 filed on Oct. 13, 2010. The entire contents of the applications are incorporated herein by reference.

### TECHNICAL FIELD

The present invention relates to a porous metal body having an aluminum skeleton and a method for producing the porous metal body, and further relates to a molten-salt battery including the porous metal body.

### BACKGROUND ART

Porous metal bodies having a three-dimensional network structure are widely used for, for example, various filters, catalyst supports, and battery electrodes. For example, Celmet (registered trademark, manufactured by Sumitomo Electric Industries, Ltd.) composed of nickel is used as an electrode material for batteries including a nickel-hydrogen battery and a nickel-cadmium battery. Celmet is a porous metal body having continuous pores and has a higher porosity (90% or more) than other porous bodies including metal non-woven fabrics. Celmet is produced by forming a nickel layer on the surface of the skeleton of a porous resin body having continuous pores such as a urethane foam, decomposing the foamed resin molded body by a heat treatment, and further subjecting the nickel layer to a reduction treatment. The nickel layer is formed in the following manner: the foamed resin molded body is subjected to a conductive treatment by applying, for example, carbon powder to the surface of the skeleton thereof, and nickel is then deposited on the surface by electroplating.

In battery applications, aluminum is used for, for example, the positive electrode of a lithium-ion battery: an aluminum foil whose surfaces are coated with an active material such as lithium cobalt oxide is used as the positive electrode. To increase the capacity of the positive electrode, a porous aluminum body may be employed so that a large surface area is provided and the porous aluminum body is filled with an active material. In this case, even when the electrode is thick, the active material therein is available and the availability ratio of the active material per unit area can be increased.

Examples of the porous aluminum body include an aluminum non-woven fabric formed by intertwining aluminum fibers and an aluminum foam formed by foaming aluminum. Patent Document 1 discloses a method for producing a metal foam containing a large number of closed pores by stirring molten metal to which a blowing agent and a thickener have been added. Patent Document 2 describes a method for producing a porous metal body in which the method for producing Celmet is applied to aluminum: a film composed of a metal (such as copper) that can form a eutectic alloy with aluminum at a temperature equal to or less than the melting point of aluminum is formed on the skeleton of a foamed resin molded body having a three-dimensional network structure; aluminum paste is then applied onto the film; the resultant body is heat-treated in a non-oxidizing atmosphere at a temperature of 550° C. or more and 750° C. or less so that the organic constituent (resin foam) is evaporated and the aluminum powder is sintered to provide a porous metal body.

### CITATION LIST

### Patent Literature

Patent Document 1: Japanese Patent No. 4176975
Patent Document 2: Japanese Unexamined Patent Application Publication No. 8-170126

### SUMMARY OF INVENTION

### Technical Problem

An aluminum non-woven fabric and an aluminum foam tend to have an oxidized film thereon because oxidation tends to proceed while aluminum is cooled after having been heated to a temperature equal to or more than the melting point thereof in the production process. Aluminum is susceptible to oxidation and it is difficult to reduce oxidized aluminum at a temperature equal to or less than the melting point. Accordingly, an aluminum non-woven fabric and an aluminum foam that have a thin oxidized film are not obtained. In addition, although an aluminum foam containing closed pores has a large surface area as a result of foaming, effective use of the entire surface of the closed pores cannot be achieved. Accordingly, when such an aluminum foam is used as a battery electrode material (current collector), it is difficult to increase the use efficiency of the active material.

Use of the method according to Patent Document 2 results in the formation of a eutectic alloy layer of aluminum and hence an aluminum layer having a high purity cannot be formed. In addition, since the heat treatment needs to be performed at a temperature around the melting point of aluminum to sinter aluminum, an oxidized film may be formed on the aluminum surface even in the non-oxidizing atmosphere.

The inventors of the present invention are developing a molten-salt battery containing a molten salt that mainly contains, as cations, sodium (Na) ions and melts at 90° C. or less. This molten-salt battery may employ metal Na as the active material of the negative electrode. In this case, however, the efficiency of the charge-discharge cycle is decreased due to dendrite growth of Na and Na softens with an increase in the temperature. To address such problems, a Na-tin alloy may be employed to achieve a high hardness: specifically, a tin layer is first formed on a current collector and Na is supplied thereto through charge to thereby form the Na-tin alloy. The current collector is preferably formed of aluminum because a current collector that is lightweight and has a high collecting property is provided.

Accordingly, it is an object of the present invention to provide a porous metal body that has a three-dimensional network structure, contains aluminum, and is suitably used as an electrode of a molten-salt battery; a method for producing the porous metal body; and a molten-salt battery including the porous metal body.

### Solution to Problem

The present invention provides a porous metal body including a porous skeleton that forms a three-dimensional network structure and includes an aluminum layer having a thickness of 1 to 100 and tin layers disposed on an internal surface and an external surface of the aluminum layer.

When a porous metal body having such a network structure and a large surface area is used as a battery electrode, the active material can be efficiently supported on the surface of the current collector, contributing to an increase in the battery capacity and the charge-discharge efficiency. In particular, according to the present invention, a tin layer functioning as the active material is disposed not only on the external surface but also on the internal surface of the aluminum skeleton serving as the current collector. Accordingly, a battery including a current collector in which an active material is also supported within the internal spaces of the skeleton can be operated. Therefore, the amount of the active material and the electrode area are increased and hence the capacity can be increased.

The tin layers preferably have a thickness of 0.5 μm or more and less than 10 μm. In the case of using the porous metal body as a battery electrode, when the thickness is less than 0.5 μm, the amount of the active material is not sufficient. When the thickness is 10 μm or more, Na forms an alloy with tin to large depths of the tin layers, resulting in degradation of the charge-discharge properties.

Such a porous metal body can be produced by a method for producing a porous metal body, the method including an internal-tin-layer formation step of forming a tin layer on a surface of a resin molded body having a three-dimensional network structure; an aluminum-skeleton formation step of forming an aluminum layer serving as an aluminum skeleton on a surface of the internal tin layer; an external-tin-layer formation step of forming a tin layer on a surface of the aluminum skeleton; and a resin removal step of removing the resin molded body, the resin removal step being performed after the aluminum-skeleton formation step or after the external-tin-layer formation step.

While the inventors of the present invention performed thorough studies on how to develop a porous aluminum body suitable for a battery electrode, they considered that not only the external surface of the porous body but also the internal surface, that is, the porous skeleton can be made to contribute to the battery operation. The inventors then conceived that, prior to the formation of an aluminum skeleton, a metal layer to serve as an active material can be formed on the surface of a resin molded body and this metal layer can also be used as a conductive layer for aluminum plating. Thus, the inventors have accomplished the present invention. When such a production method is employed, the formation of a conductive layer on the surface of a resin body also serves as the formation of an active-material layer in the production process of a porous aluminum body, which allows for efficient production.

The resin removal step preferably includes a nitric-acid treatment process of decomposing the resin molded body on which metal layers have been formed, by bringing the resin molded body into contact with concentrated nitric acid having a concentration of 62% or more.

The resin molded body is generally formed of urethane (polyurethane). The inventors of the present invention have found that urethane can be removed through decomposition in concentrated nitric acid, though urethane is less likely to dissolve in organic solvents. Aluminum dissolves in acids and alkalis. However, in concentrated nitric acid, which is an oxidizing acid, a very thin oxidized film (passivation film) is formed in the surface of aluminum and aluminum is not further dissolved. The inventors of the present invention have found a concentration of concentrated nitric acid that is optimum for allowing removal of urethane through decomposition and for not dissolving aluminum. Tin also dissolves in concentrated nitric acid. However, since decomposition of urethane proceeds faster than dissolution of tin, by completing the treatment process after a proper treatment time has elapsed, the resin removal step can be completed such that tin remains.

Consider a case where the resin removal step is performed after the aluminum-skeleton formation step and before the external-tin-layer formation step. As a result of the resin removal step, a tin layer having a proper thickness is made to remain on the internal surface, whereas the external surface is formed of aluminum. In this state, the external-tin-layer formation step is then performed to form a tin layer. Alternatively, consider a case where the resin removal step is performed after the external-tin-layer formation step. In this case, a portion of the external tin layer is also dissolved during the resin removal. However, by forming the tin layer so as to have a sufficiently large thickness in advance and by properly selecting the time for the resin removal, the tin layer can be made to remain so as to have a desired thickness.

The present invention also provides a molten-salt battery including, as a negative electrode member, the above-described porous metal body. The current collector composed of aluminum is formed as a porous body; and a tin layer serving as an active material is provided not only on the external surface but also on the internal surface of the porous skeleton composed of aluminum. As a result, when this porous metal body is used as a negative-electrode member and an electrode including this member is prepared, a high-performance battery having a high capacity can be provided.

The resin removal step preferably further includes a solvent treatment process of removing decomposition matter of the resin molded body by bringing the decomposition matter into contact with an organic solvent, the solvent treatment process being performed after the nitric-acid treatment process. This is because the urethane removal percentage can be increased.

### Advantageous Effects of Invention

The present invention can provide a porous metal body that has a three-dimensional network structure, contains aluminum, and is suitably used as an electrode of a molten-salt battery; a method for producing the porous metal body; and a molten-salt battery including the porous metal body.

### BRIEF DESCRIPTION OF THE DRAWINGS

FIG. 1 is a flow chart illustrating steps for producing a porous metal body according to the present invention.

FIG. 2 is a schematic sectional view for illustrating steps for producing a porous metal body according to the present invention.

FIG. 3 is an enlarged photograph illustrating a surface structure of a urethane resin foam serving as an example of a porous resin molded body.

FIG. 4 is a schematic sectional view illustrating a structural example in which a porous metal body is applied to a molten-salt battery.

### DESCRIPTION OF EMBODIMENTS

Hereinafter, embodiments according to the present invention will be described. The same or similar components in the drawings referred to below are denoted with identical reference signs. The present invention is not limited to these embodiments. The scope of the present invention is indicated by the Claims and is intended to embrace all the modifications within the meaning and range of equivalency of the Claims.

### (Steps for Producing Porous Metal Body)

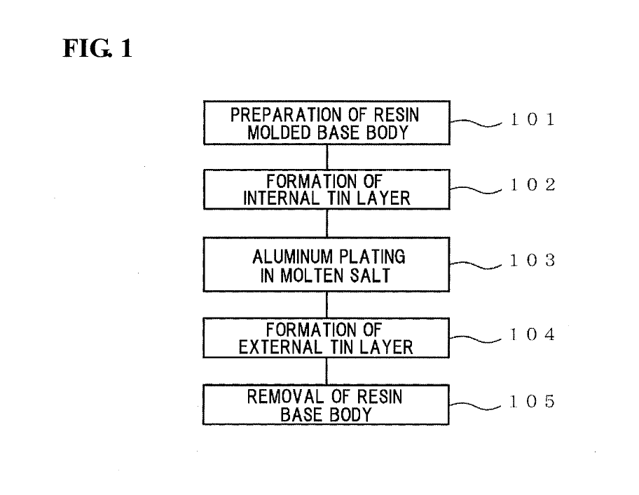

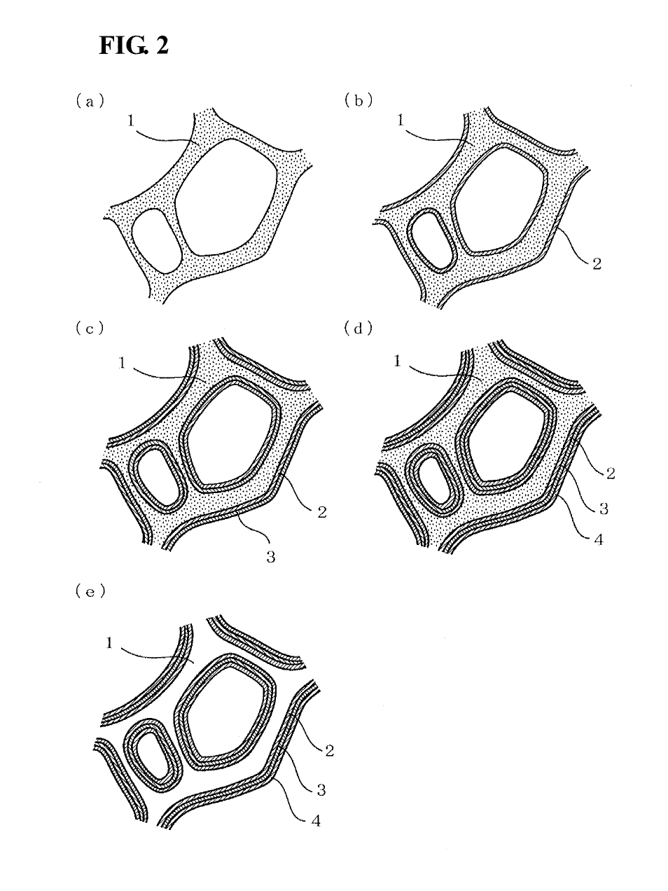

FIG. 1 is a flow chart illustrating steps for producing a porous metal body according to the present invention. Corresponding to this flow chart, FIG. 2 schematically illustrates formation of a porous metal body in which a resin molded body serves as a core material. The overall flow of the production steps will be described with reference to FIGS. 1 and 2. “Preparation of a resin molded base body” 101 is first performed. FIG. 2(a) is an enlarged schematic view illustrating an enlarged partial resin section of the surface of a foamed resin molded body having continuous pores, the foamed resin molded body serving as an example of the resin molded base body. The pores are formed in a foamed resin molded body 1 serving as a skeleton. “Formation of a tin layer” 102, the tin layer being to serve as an internal tin layer, is then performed; this step is also intended to make the surface of the resin molded body be conductive. As a result of this step, referring to FIG. 2(b), a tin layer 2 having a small thickness is formed on the surface of the resin molded body 1. “Aluminum plating in a molten salt” 103 is then performed to form an aluminum plating layer 3 on the surface of the resin molded body having the tin layer (FIG. 2(c)). Thus, an aluminum-coated resin molded body in which the aluminum plating layer 3 is formed on the surface of the resin molded body serving as a base material is provided. “Formation of a tin layer 4” 104 on the surface of the aluminum plating layer is then performed (FIG. 2(d)). Thus, the structure of tin layer/aluminum layer/tin layer has been formed on the surface of the resin molded base body. As described below, however, this trilayer structure is not limitative: for example, when a zinc layer is formed for the formation of a tin layer, the zinc layer may be interposed in the structure. “Removal of the resin molded base body” 105 is then performed. For example, by bringing the aluminum-coated resin molded body into contact with concentrated nitric acid having a concentration of 62% or more to remove the foamed resin molded body 1 through decomposition, only the metal layers remain and a porous metal body (porous body) having a porous skeleton can be provided (FIG. 2(e)). The “removal of the resin base body” 105 may be performed before the “formation of the external tin layer” 104 in FIG. 1. In this case, the external tin layer is readily formed so as to have a desired thickness without being affected by the step of removing the base body. Hereinafter, the steps will be sequentially described.

### (Preparation of Porous Resin Molded Body)

A resin molded body having a three-dimensional network structure and continuous pores, for example, a foamed resin molded body composed of urethane is prepared. A resin molded body having any form can be selected as long as it has continuous pores (open pores). For example, a resin molded body that has a form similar to non-woven fabric and is prepared by intertwining resin fibers may be used instead of the foamed resin molded body. The foamed resin molded body preferably has a porosity of 80% to 98% and a pore diameter of 50 to 500 μm. A urethane foam has a high porosity, continuity of pores, and high uniformity of pores and hence is preferably used as the foamed resin molded body.

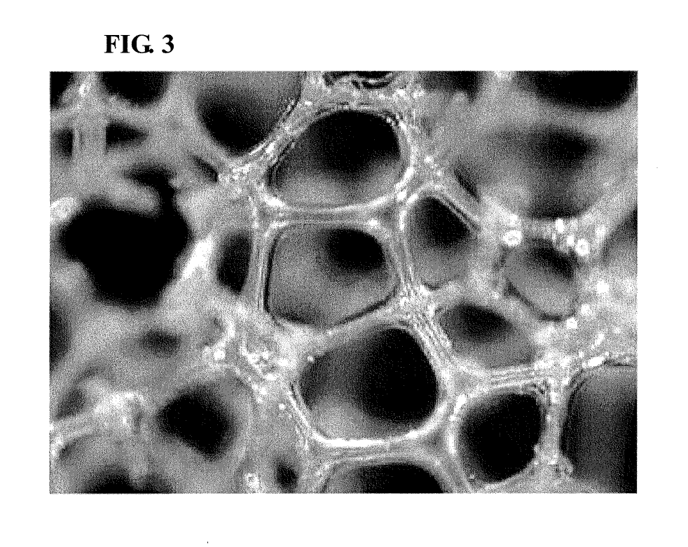

Since the foamed resin molded body often contains residual materials including a foaming agent and an unreacted monomer that are derived from the production of the foam, it is preferably subjected to a washing treatment for the purpose of properly performing the subsequent steps. As an example of the foamed resin molded body, a urethane foam having been subjected to a washing treatment is illustrated in FIG. 3. In this resin molded body, the skeleton forms a three-dimensional network to thereby constitute generally continuous pores. The skeleton of a urethane foam has a substantially triangular shape in a cross section perpendicular to the extended direction. The porosity is defined by the following equation.

Porosity=(1−(Weight of porous material[g]/(Volume of porous material[cm³]×Material density)))×100[%]

The pore diameter is determined in the following manner. The surface of the resin molded body is magnified with, for example, a photomicrograph. The cell number per inch (25.4 mm) is counted and the pore diameter is calculated as an average value with an equation: Average pore diameter=25.4 mm/cell number.

### (Formation of Tin Layer on Surface of Resin Molded Body: Gas Phase Method)

The internal tin layer functioning as a conductive layer is first formed on the surface of the foamed resin molded body. This tin layer may be formed by a desired method selected from, for example, gas phase methods including vapor deposition, sputter, and plasma chemical vapor deposition and application of a tin coating material. Of these, vapor deposition is preferred because a thin film can be uniformly formed. The internal tin layer preferably has a thickness of 0.5 to 10 μm, more preferably 1.5 to 5 μm. When the internal tin layer has a thickness of at least 0.1 μm, the foamed resin molded body is sufficiently made conductive for the aluminum plating. In the case of using the porous metal body as the negative electrode of a molten-salt battery, when the internal tin layer has a thickness of less than 0.5 μm, the amount of the active material is insufficient and the active material does not effectively function; when the internal tin layer has a thickness of more than 10 μm, gaps in the pores of the skeleton are excessively small and the active material does not effectively function.

### (Pretreatment for Plating: Anode Electrolysis)

The tin layer formed in the above-described step is to be plated with aluminum by molten-salt plating to form an aluminum plating layer. At this time, when an oxidized film is present in the surface of the conductive layer, the adhesion of aluminum to the conductive layer becomes poor in the subsequent plating step, and aluminum may adhere in an island pattern or the aluminum plating layer may have variations in the thickness. Accordingly, prior to the plating step, anode electrolysis is preferably performed to dissolve and remove an oxidized film formed in the surface of the tin layer. Specifically, the resin molded body having the tin layer and a counter electrode such as an aluminum plate are immersed in a molten salt; direct-current electricity is applied between the resin molded body (conductive layer) serving as an anode and the counter electrode serving as a cathode. The molten salt may be the same as or different from that used in the subsequent molten-salt plating step.

### (Pretreatment for Plating: Non-Oxidizing Atmosphere)

Alternatively, to suppress oxidization of the tin layer, after the formation of the tin layer, the resin molded body may be moved to the subsequent plating step without being exposed to any oxidizing atmosphere. For example, a vapor-deposition apparatus and a molten-salt plating apparatus are installed in an argon atmosphere; the sample is subjected to the conductive step by vapor deposition in the argon atmosphere; and the sample is then transferred through the argon atmosphere to the subsequent step, that is, the molten-salt plating. By employing this method, the surface of the tin layer formed in the previous step can be plated without being oxidized.

### (Formation of Aluminum Layer: Molten-Salt Plating)

The resin molded body is then subjected to electroplating in a molten salt to form an aluminum plating layer on the surface of the resin molded body. In a molten salt, direct-current electricity is applied between a negative electrode that is the resin molded body whose surface is made conductive with the tin layer and a positive electrode that is an aluminum plate having a purity of 99.99%. The aluminum plating layer has a thickness of 1 to 100 μm, preferably 5 to 20 μm. The molten salt may be an organic molten salt that is a eutectic salt between an organohalide and an aluminum halide, or an inorganic molten salt that is a eutectic salt between a halide of an alkali metal and an aluminum halide. Use of a bath of an organic molten salt that melts at a relatively low temperature is preferred because the resin molded body serving as the base material can be plated without being decomposed. Examples of the organohalide include imidazolium salts and pyridinium salts. In particular, 1-ethyl-3-methylimidazolium chloride (EMIC) and butylpyridinium chloride (BPC) are preferred. The imidazolium salts are preferably salts including an imidazolium cation having alkyl groups at the 1 and 3 positions. In particular, an aluminum chloride/1-ethyl-3-methylimidazolium chloride (AlCl₃-EMIC) molten salt is most preferably used because it is highly stable and is less likely to decompose.

Since entry of water or oxygen into the molten salt results in deterioration of the molten salt, plating is preferably performed in an atmosphere of an inert gas such as nitrogen or argon and in a sealed environment. When an EMIC bath is used as the organic-molten-salt bath, the temperature of the plating bath is 10° C. to 60° C., preferably 25° C. to 45° C.

When an imidazolium-salt bath is used as the molten-salt bath, an organic solvent is preferably added to the molten-salt bath. In particular, the organic solvent is preferably xylene. Addition of an organic solvent, in particular, xylene provides special effects to the formation of a porous aluminum body: specifically, a first advantage that the aluminum skeleton forming the porous body is less likely to be broken and a second advantage that uniform plating can be achieved such that the difference in plating thickness is small between the surface portion and the internal portion of the porous body. As for the first advantage, the addition of an organic solvent improves the plating on the surface of the skeleton from granular shape (having large irregularities and being seen as granules in surface observation) to a planar shape and, as a result, the thin and narrow skeleton is strengthened. As for the second advantage, the addition of an organic solvent to the molten-salt bath results in a decrease in the viscosity of the molten-salt bath and, as a result, the plating bath can readily circulate to the inside of the fine network structure. Specifically, when the plating bath has a high viscosity, a new feed of the plating bath readily reaches the surface of the porous body, whereas it is less likely to reach the inside of the porous body; accordingly, by decreasing the viscosity of the plating bath, the plating bath also readily reaches the inside and a plating having a uniform thickness can be formed. The amount of an organic solvent added to the plating bath is preferably 25 to 57 mol %. When the amount is 25 mol % or less, the effect of reducing the thickness difference between the surface layer and the inside is less likely to be provided. When the amount is 57 mol % or more, the plating bath becomes unstable and the plating solution and xylene become partially separated from each other.

In addition to the plating step with a molten-salt bath to which an organic solvent is added, a washing step using the organic solvent as a cleaning liquid is preferably subsequently performed. The plated resin surface needs to be washed to remove the plating bath. Such washing after plating is generally performed with water. However, washing with water causes entry of water in the form of, for example, water vapor to the plating solution while imidazolium-salt baths need to avoid water. To avoid washing with water that adversely affects plating, washing with an organic solvent is advantageously employed. In the above-described case where an organic solvent is added to a plating bath, washing with the organic solvent added to the plating bath provides additional advantage. Specifically, the plating solution can be relatively easily collected and recycled through washing, which can result in cost reduction. For example, consider a case where a plated body to which a bath containing a molten salt AlCl₃-EMIC and xylene is adhering is washed with xylene. This washing provides a solution containing a larger amount of xylene than the plating bath used. Since the amount of the molten salt AlCl₃-EMIC mixing with xylene is limited, the solution is separated into an upper portion composed of xylene and a lower portion composed of the molten salt AlCl₃-EMIC containing about 57 mol % xylene; extraction of this separated lower portion of the solution enables collection of the molten solution. In addition, since xylene has a low boiling point of 144° C., the collected molten salt may be heated such that the xylene concentration is adjusted to be the concentration in the plating solution; thus, the resultant solution can be recycled as the plating solution. After the washing with an organic solvent, the plated body is preferably further washed with water in another place that is away from the plating bath.

### (Formation of Tin Layer on Aluminum Surface)

A tin layer is formed on the surface of the aluminum layer by, for example, plating. This plating may be performed by electroplating in which tin is electrochemically deposited on the current collector composed of Al or electroless plating in which tin is chemically deposited by reduction. An oxidized film is likely to be formed in the aluminum surface. When a tin layer is directly formed on the aluminum surface having an oxidized film, the tin layer tends to become separated. Accordingly, the aluminum surface is preferably subjected to zinc-substitution plating before a tin film is formed thereon by tin plating. The zinc-substitution plating proceeds while removing the oxidized film. Accordingly, a zinc film is formed so as to penetrate the oxidized film and the tin plating film can be formed on this zinc film so as to have a high adhesion to the zinc film. Specifically, the zinc-substitution plating solution is strongly alkaline; when the dissolution of the oxidized film proceeds and the underlying aluminum is exposed, zinc ions gain electrons from aluminum so that zinc deposits and aluminum dissolves; and a zinc plating film can be sufficiently formed. Accordingly, since the zinc plating film has a high adhesion and it is formed by plating, the thickness of the zinc plating film can be reduced.

Specifically, as a pretreatment, a soft etching treatment of removing the oxidized film of the current collector with an alkaline etchant is first performed. A desmutting (dissolved residue removal) treatment with nitric acid is then performed. After the current collector is washed with water, the surface of the current collector from which the oxidized film has been removed is subjected to a zincate treatment (zinc-substitution plating) with a zincate treatment solution to form a zinc film. At this time, the zinc film may be peeled and another zincate treatment may be performed. In this case, a zinc film that is denser and thinner can be formed and it has a higher adhesion to the aluminum layer, which suppresses release of zinc.

The current collector having the zinc film is then dipped in a plating bath containing a plating solution to perform tin plating; as a result, a tin plating film is formed (tin plating step).

The following is an example of plating conditions for forming the tin plating film by electroplating.

Composition of Plating Solution
SnSO₄: 40 g/dm³
H₂SO₄: 100 g/dm³
cresolsulphonic acid: 50 g/dm³
formaldehyde (37%): 5 ml/dm³
gloss agent

pH: 4.8

Temperature: 20° C. to 30° C.

Current density: 2 A/dm²

Anode: tin

Treatment time: 600 seconds (in the case where the thickness of the tin plating film is about 10 μm)

Prior to the formation of the tin plating film, a nickel plating film may be formed on the zinc film. The following is an example of plating conditions for forming the nickel plating film.

Composition of Plating Solution
nickel sulphate: 240 g/L
nickel chloride: 45 g/L
boracic acid: 30 g/L

pH: 4.5

Temperature: 50° C.

Current density: 3 A/dm²

Treatment time: 330 seconds (in the case where the film thickness is about 3 μm)

By forming this nickel plating film as an intermediate layer, an acidic or alkaline plating solution can be used for performing the tin plating. When the Ni plating film is not formed and an acidic or alkaline plating solution is used, zinc is released into the plating solution.

In the above-described tin plating step, the Sn plating film is preferably formed so as to have a thickness of 0.5 μm or more and 200 μm or less. This film thickness can be adjusted by, for example, changing the time for which the current collector is dipped in the plating solution. When the film thickness is 0.5 μm or more and 200 μm or less, in the case of using the porous metal body as the negative electrode of a molten-salt battery, a desired electrode capacity is provided and, for example, a problem that the Sn plating film is broken due to expansion caused by change in the volume and a short circuit occurs is suppressed. When the Sn plating film forms an alloy with Na due to occlusion of sodium ions, the electrode has a higher surface hardness than the Na negative electrode. The film thickness is preferably 0.5 μm or more and 100 μm or less because breaking of the film is further suppressed. The film thickness is more preferably 0.5 μm or more and 50 μm or less because the capacity maintenance rate of charge and discharge is further increased. The film thickness is still more preferably 1 μm or more and 20 μm or less because a decrease in the discharge voltage can be suppressed. The film thickness is most preferably 5 μm or more and 10 μm or less because the capacity maintenance rate is further increased and the surface hardness of the negative electrode is further increased.

A zinc diffusion process of diffusing zinc into the aluminum layer is preferably performed. This zinc diffusion process may be performed by, for example, a heat treatment at a temperature of 200° C. or more and 230° C. or less for about 30 seconds to 5 minutes. Depending of the thickness of the zinc film, the heat-treatment temperature may be increased to 400° C. or more. Although the zinc diffusion process may be eliminated, the heat treatment allows for diffusion of zinc into the aluminum layer; as a result, when the porous metal body is used as the negative electrode of a molten-salt battery, charge and discharge due to zinc are suppressed to enhance the charge-discharge cycle properties of the battery and generation of dendrite is suppressed to enhance the safety.

(Decomposition of Resin: Treatment with Concentrated Nitric Acid)

As a result of the above-described steps, a metal-coated resin molded body having a resin molded body serving as the skeleton core is obtained. This resin base body is then removed. The metal-coated resin molded body is brought into contact with concentrated nitric acid, which is an oxidizing acid. The metal-coated resin molded body may be immersed in a solution of concentrated nitric acid. Alternatively, a solution of concentrated nitric acid may be sprayed on the metal-coated resin molded body. The solution of concentrated nitric acid has a concentration of 62% or more. As a result of this step, urethane is decomposed so as to have low molecular weights and can be removed through dissolution in nitric acid. Aluminum is not substantially dissolved and a porous structure derived from the foamed resin molded body is maintained. Although tin dissolves in nitric acid, by properly selecting the treatment time, tin layers having desired thicknesses can be made to remain. Specifically, as for the internal tin layer, since urethane is first decomposed and then the tin layer starts to dissolve, the tin layer can be made to have a desired thickness by completing the treatment in view of the time over which an intended amount of the tin layer is dissolved. The external tin layer can be made to have a desired thickness by forming the external tin layer by plating so as to have a thickness in view of a decrease in the thickness through dissolution during decomposition of urethane.

When the nitric acid has a concentration of less than 62%, urethane is decomposed to a certain degree so as to have relatively low molecular weights, but solid matter remains and the urethane cannot be completely removed. When the concentration is less than 62%, the amount of the metal layers dissolved becomes large and a desired porous metal body cannot be obtained. Although the upper limit of the concentration of concentrated nitric acid is not particularly limited, it is practically about 70%. Since concentrated nitric acid is a solution having a low viscosity, the solution tends to enter fine portions of the porous metal-coated resin molded body and hence urethane can be uniformly decomposed.

### (Decomposition of Resin: Heat Treatment)

In the above-described step, urethane is removed to provide a porous metal body. The porous metal body is preferably further subjected to a post-treatment because a small amount of urethane decomposition matter having low molecular weights remains in the porous metal body. For example, the post-treatment may be performed by a heat treatment at a temperature lower than the above-described heat-treatment temperature or by bringing the porous metal body into contact with an organic solvent. In the case of the low-temperature heat treatment, the heat treatment is preferably performed at a temperature of 200° C. or more and 230° C. or less. Since urethane remaining in the porous metal body has been made to have low molecular weights by the nitric-acid treatment process, it is decomposed and removed at such a temperature. The temperature is made 230° C. or less because the heat treatment is performed at a temperature equal to or less than the melting point of tin. Although, at such a temperature, urethane can be removed without substantially causing oxidization of the metal layers, the heat treatment is preferably performed in an inert-gas atmosphere to suppress the oxidization. By removing the resin in this manner, the thickness of an oxide layer in the surface can be made small (the oxygen content can be made low). To remove the urethane residue more efficiently, the heat treatment is preferably performed under flow of a gas such as nitrogen gas.

(Decomposition of Resin: Treatment with Organic Solvent)

The post-treatment may be performed by bringing the porous metal body into contact with an organic solvent: the porous metal body having been subjected to the treatment using concentrated nitric acid may be immersed in an organic solvent, and an organic solvent may be sprayed on the porous metal body having been subjected to the treatment using concentrated nitric acid. These post-treatment processes may be performed alone or in combination. The organic solvent may be freely selected from, for example, acetone, ethanol, and toluene. Halogen-based organic solvents including bromine-based solvents, chlorine-based solvents, and fluorine-based solvents have high solvency and are non-flammable and hence are preferred in view of safety.

The steps for forming the porous metal body have been described so far. As described above, the resin base body may be removed after the molten-salt aluminum plating and before the formation of the tin layer.

### (Molten-Salt Battery)

A porous metal body according to the present invention is preferably used as a negative electrode material for a molten-salt battery including a molten salt that mainly contains, as cations, sodium (Na) ions and melts at 90° C. or less. When Na is used as the negative-electrode active material in such a battery, since Na has a low melting point of 98° C. and tends to soften with an increase in the temperature, Na may be made to form an alloy with tin (Sn) to thereby achieve a higher hardness. In this case, a tin layer is first formed on the current collector and Na is then supplied thereto through charge to thereby form a Na—Sn alloy. The current collector is preferably composed of aluminum because a current collector that is lightweight and has a high collecting property is provided. A porous metal body according to the present invention has a structure in which an aluminum skeleton serving as a current collector is bonded to tin layers and these active material layers are present inside and outside of the porous skeleton. Accordingly, the porous metal body allows for a high battery capacity.

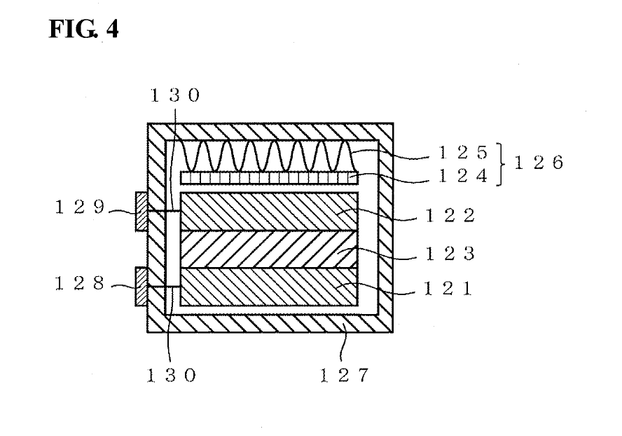

FIG. 4 is a schematic sectional view of a molten-salt battery, as an example, including the above-described porous metal body serving as a battery electrode material. For example, the molten-salt battery has a structure in which the following components are contained in a case 127: a positive electrode 121 in which a positive-electrode active material is supported on the surface of an aluminum skeleton of a porous metal body having an aluminum surface; a negative electrode 122 that is a porous metal body in which tin layers are disposed on aluminum surfaces; and a separator 123 impregnated with a molten salt serving as an electrolyte. A pressing member 126 constituted by a presser plate 124 and a spring 125 pressing the presser plate is disposed between the upper surface of the case 127 and the negative electrode. Even when the volumes of the positive electrode 121, the negative electrode 122, and the separator 123 vary, the pressing member uniformly presses these components so that these components are in contact with one another. The current collector (porous aluminum body) of the positive electrode 121 and the current collector (porous aluminum body having tin layers) of the negative electrode 122 are respectively connected to a positive-electrode terminal 128 and a negative-electrode terminal 129 through leads 130.

The molten salt serving as the electrolyte may be selected from various inorganic salts and organic salts that melt at the operation temperature. The cation of the molten salt may be one or more selected from alkali metals including lithium (Li), sodium (Na), potassium (K), rubidium (Rb), and cesium (Cs) and alkaline earth metals including beryllium (Be), magnesium (Mg), calcium (Ca), strontium (Sr), and barium (Ba).

To decrease the melting point of the molten salt, two or more salts are preferably used in combination. For example, when potassium bis(fluorosulfonyl)amide (KFSA) and sodium bis(fluorosulfonyl)amide (NaFSA) are used in combination, the operation temperature of the battery can be made 90° C. or less.

The molten salt is used such that a separator is impregnated therewith. The separator is configured to prevent the positive electrode and the negative electrode from coming into contact with each other. The separator may be formed of, for example, glass non-woven fabric or porous resin. The positive electrode, the negative electrode, and the separator impregnated with the molten salt are stacked and contained in a case, and used as a battery.

The above-described description encompasses other embodiments described below.

### Another First Embodiment

A porous metal body including:

a porous skeleton that forms a three-dimensional network structure and includes an aluminum layer having a thickness of 1 to 100 μm,

tin layers disposed on an internal surface and an external surface of the aluminum layer, and

a zinc layer disposed between the aluminum layer and the tin layer disposed on the external surface.

### Another Second Embodiment

A method for producing a porous metal body, including:

an internal-tin-layer formation step of forming a tin layer on a surface of a resin molded body having a three-dimensional network structure;

an aluminum-skeleton formation step of forming an aluminum layer serving as an aluminum skeleton on a surface of the internal tin layer;

an external-tin-layer formation step of forming a tin layer on a surface of the aluminum skeleton; and

a resin removal step of removing the resin molded body, the resin removal step being performed after the aluminum-skeleton formation step or after the external-tin-layer formation step,
the external-tin-layer formation step including a step of forming a zinc film on the surface of the aluminum layer by zinc-substitution plating, and
a step of plating a surface of the zinc film with tin.

### REFERENCE SIGNS LIST

1 foamed resin
2 internal tin layer
3 aluminum plating layer
4 external tin layer
121 positive electrode
122 negative electrode
123 separator
124 presser plate
125 spring
126 pressing member
127 case
128 positive electrode terminal
129 negative electrode terminal
130 lead

What is claimed is:

1. A porous metal body comprising:
a porous skeleton that forms a three-dimensional network structure and includes an aluminum layer having a thickness of 1 to 100 μm, and
tin layers disposed on an internal surface and an external surface of the aluminum layer.

2. The porous metal body according to claim 1, wherein the tin layers have a thickness of 0.5 μm or more and less than 10 μm.

3. A method for producing a porous metal body, comprising:
an internal-tin-layer formation step of forming a tin layer on a surface of a resin molded body having a three-dimensional network structure;
an aluminum-skeleton formation step of forming an aluminum layer serving as an aluminum skeleton on a surface of the internal tin layer;
an external-tin-layer formation step of forming a tin layer on a surface of the aluminum skeleton; and
a resin removal step of removing the resin molded body, the resin removal step being performed after the aluminum-skeleton formation step or after the external-tin-layer formation step.

4. The method according to claim 3, wherein the resin removal step includes a nitric-acid treatment process of decomposing the resin molded body on which metal layers have been formed, by bringing the resin molded body into contact with concentrated nitric acid having a concentration of 62% or more.

5. The method according to claim 4, wherein the resin removal step further includes a solvent treatment process of removing decomposition matter of the resin molded body by bringing the decomposition matter into contact with an organic solvent, the solvent treatment process being performed after the nitric-acid treatment process.

6. A negative-electrode member for a molten-salt battery, comprising the porous metal body according to claim 1.

7. A negative-electrode member for a molten-salt battery, comprising a porous metal body produced by the method according to claim 3.

8. A molten-salt battery comprising, as a negative electrode, a porous metal body having a three-dimensional network structure including a metal skeleton layer that is porous and includes an aluminum layer, and tin layers covering internal and external surfaces of the metal skeleton layer.
